(19) United States
(12) Patent Application Publication
(10) Pub. No.: US 2025/0256949 A1
(43) Pub. Date: Aug. 14, 2025

(54) Corkscrew

(71) Applicant: Dean Lodmell, Walla Walla, WA (US)

(72) Inventor: Dean Lodmell, Walla Walla, WA (US)

(21) Appl. No.: 18/438,759

(22) Filed: Feb. 12, 2024

(51) Int. Cl. B67B 7/04; B67B 7/06

(52) U.S. Cl. CPC B67B 7/0405; B67B 7/0411; B67B 7/0435; B67B 7/063

(57) ABSTRACT

A corkscrew which is designed to break the seal between the bottle and the cork by pressing the cork down into the bottle before removal. This compression allows the seal to be broken between the bottle and the cork which allows the cork to be pulled with less force on the cork itself.

### BACKGROUND OF THE INVENTION

Corkscrews damaging the cork is a common problem for wine drinkers. These normal corkscrews tend to break corks from old bottles. Osso or fingered corkscrews scratch and damage the outside of corks, and the Durand corkscrew contains an Osso in its design which also damages or scratches the outside of the cork.

The present subject matter resolves these issues by initially compressing the cork as opposed to pulling the cork apart. This compression allows the seal to be broken between the bottle and the cork which allows the cork to be pulled with less force on the cork itself.

### SUMMARY OF THE INVENTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements and are not drawn to scale. least one specification heading is required.

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

The present subject matter is a device permanently or temporarily attaches to a corkscrew, worm of a corkscrew, or other device to remove corks. The present subject matter attaches to a handle which allows for the cork to be partially pushed into the bottle to break the seal between the and the cork.

The part of the device which pushes the cork is the ferrule.

While several illustrative embodiments of the invention have been shown and

described, numerous variations and alternative embodiments will occur to those skilled in the art. Such variations and alternative embodiments are contemplated and can be made without departing from the scope of the invention as defined in the appended claims.

The invention encompasses three distinct embodiments: (1) a copper ring or similar structure attached attachable to an existing manual, mechanically assisted, or electrically assisted corkscrew; (2) a copper ring or similar structure attached to a handle for use with an external corkscrew; (3) a copper ring or similar structure which can be temporarily attached to an existing corkscrew. Each embodiment caters to different needs and ensures the gentle and efficient removal of corks.

### BRIEF DESCRIPTION OF DRAWINGS

FIG. 1 shows a perspective view of the standalone corkscrew.

FIG. 2 shows a side view of the attached mechanical corkscrew.

FIG. 3 shows a side view of the attached “rabbit” style corkscrew.

FIG. 4 shows a side view of the electric corkscrew.

FIG. 5 shows a side view of the Osso style corkscrew.

FIG. 6 shows a perspective of the ferrule.

FIG. 7 shows a perspective of the ferrule and handle.

### DETAILED DESCRIPTION OF THE INVENTION

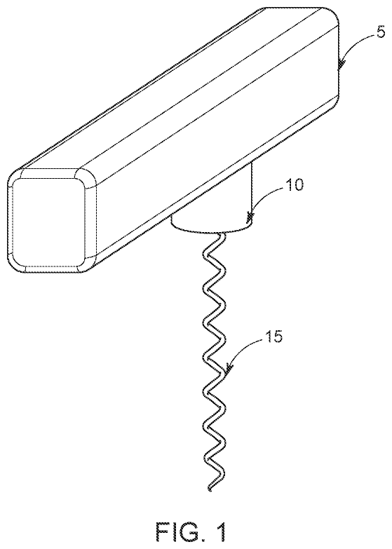

FIG. 1 shows a perspective view of the standalone corkscrew wherein the handle 5 is affixed to the top surface of the ferrule 10. The worm 15 is screwed through the ferrule into the handle.

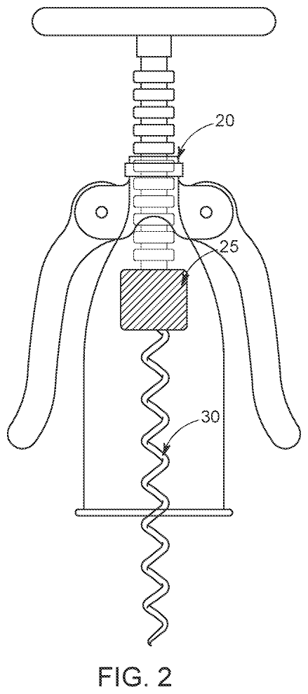

FIG. 2 shows a side view of the attached mechanical corkscrew wherein the mechanical pull 20 is affixed to the top surface of the ferrule 25 and the worm 30 is screwed through the ferrule into the mechanical pull.

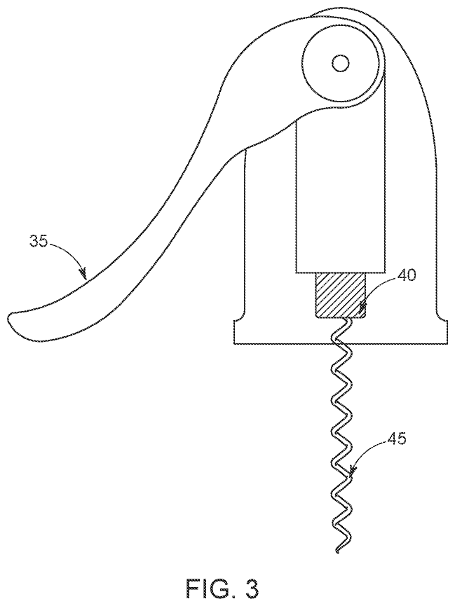

FIG. 3 shows a side view of the attached “rabbit” style corkscrew wherein the mechanical lever 35 is affixed to the top surface of the ferrule 40 and the worm 45 is screwed through the ferrule into the mechanical lever.

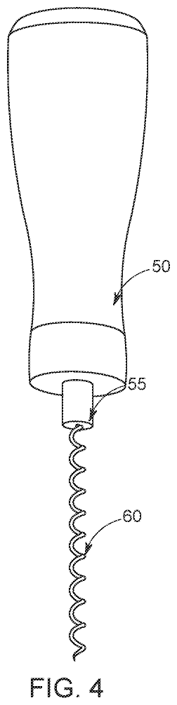

FIG. 4 shows a side view of the electric corkscrew wherein the electric portion 50 is affixed to the top surface of the ferrule 55 and the worm 60 is screwed through the ferrule into the bottom surface of the electric portion.

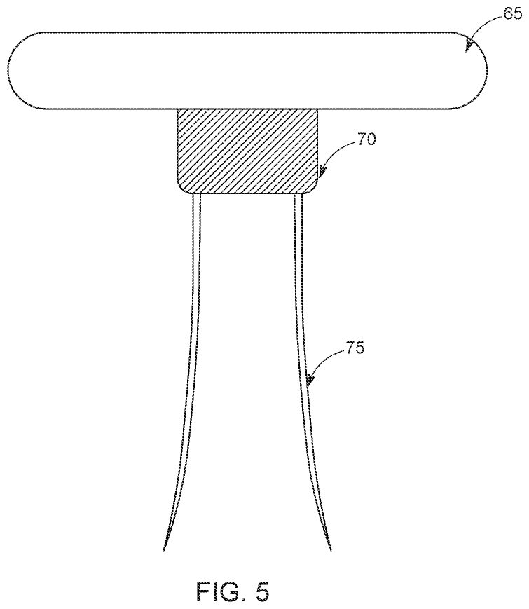

FIG. 5 shows a side view of the Osso style corkscrew wherein the handle 65 is affixed to the top surface of the ferrule 70 and the prongs 75 are affixed to the bottom surface of the ferrule.

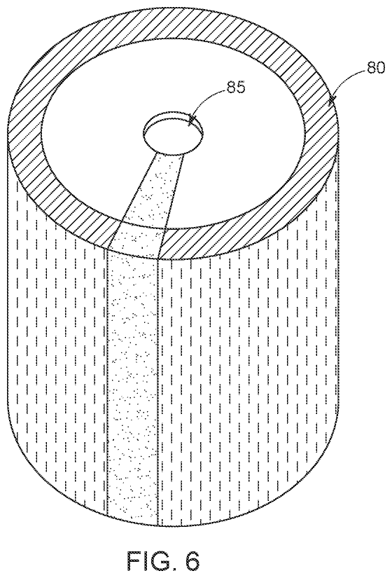

FIG. 6 shows a perspective of the ferrule 80 wherein the hole for the worm 85 is created from a central shaft that shaped like a corkscrew shaped column. In some embodiments, the ferrule has on optional slit to slide on.

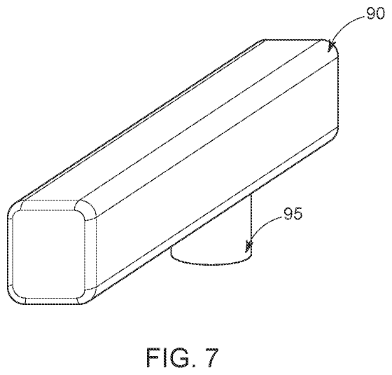

FIG. 7 shows a perspective of the ferrule and handle wherein the handle 90 is affixed to the vertical surface of the ferrule 95.

1. A corkscrew comprising of a handle, ferrule, and worm.

2. The corkscrew as in claim 1, wherein the handle is affixed to the top surface of the ferrule and the worm is screwed through the ferrule into the handle.

3. A corkscrew comprising of a handle, mechanical pull, ferrule, and worm.

4. The corkscrew as in claim 3, wherein the mechanical pull is affixed to the top surface of the ferrule and the worm is screwed through the ferrule into the mechanical pull.

5. A corkscrew comprising of a mechanical lever, ferrule, and worm.

6. The corkscrew as in claim 5, wherein the mechanical lever is affixed to the top surface of the ferrule and the worm is screwed through the ferrule into the mechanical lever.

7. A corkscrew comprising of an electric portion, ferrule, and worm.

8. The corkscrew as in claim 7, wherein the electric portion is affixed to the top surface of the ferrule and the worm is screwed through the ferrule into the bottom surface of the electric portion.

9. A corkscrew comprising of a handle, ferrule, and prongs.

10. The corkscrew as in claim 9, wherein the handle is affixed to the top surface of the ferrule and the prongs are affixed to the bottom surface of the ferrule.

11. A ferrule comprising of a hole for a worm and an optional slit.

12. The ferrule as in claim 11, wherein the hole for the worm is created from a central shaft that shaped like a corkscrew shaped column.
